(19) United States
(12) Patent Application Publication
(10) Pub. No.: US 2008/0212849 A1
(43) Pub. Date: Sep. 4, 2008

(54) Method and Apparatus For Facial Image Acquisition and Recognition

(75) Inventor: Qi Gao, Beijing (CN)

Correspondence Address: WORKMAN NYDEGGER, 60 EAST SOUTH TEMPLE, 1000 EAGLE GATE TOWER, SALT LAKE CITY, UT, 84111, US

(73) Assignee: AUTHENMETRIC CO., LTD., Beijing (CN)

(21) Appl. No.: 10/596,374

(22) PCT Filed: May 14, 2004
(86) PCT No.: PCT/CN04/00482

§ 371 Date: Jun. 9, 2006

(30) Foreign Application Priority Data
Dec. 12, 2003 (CN) 200310121340.1

(51) Int. Cl. G06K 9/00

(52) U.S. Cl. 382/118

(57) ABSTRACT

A method and apparatus for facial image acquisition and/or recognition used for person identification. In infrared face image acquisition, near infrared (NIR) images of a face are captured by an imaging unit with the face illuminated by active NIR lights; an NIR optical filter is used in the imaging unit to minimize visible lights in environments while allowing NIR lights to pass through. NIR face images thus acquired provides good image quality for the purpose of face recognition. In face recognition, eyes are localized in NIR face image(s) quickly and accurately by detecting specular highlight reflection in each eye, whereby face is then localized. The invention effectively problems caused by environmental lights, and leads to accurate and fast face recognition under variable lighting conditions. Moreover, the methods use a non-intrusive and user-friendly way of active lighting for face image acquisition and recognition because the NIR lights are in the invisible spectrum.

### TECHNICAL FIELD OF THE INVENTION

The present invention relates generally to the field of image recognition. More specifically, it relates to a method and an apparatus for facial image acquisition and recognition, wherein an active near infrared (NIR) light within invisible light spectrum is applied to illuminate a target face.

### BACKGROUND OF THE INVENTION

Face recognition is a biometric technology in which the technology related to computers, image processing, and pattern recognition is also involved to perform person identification based on facial images. Recently, especially after 9.11 terror attacks, many countries in the world have attached a great importance to their public security. Accordingly, face recognition technology has been greatly noticed much more than ever before.

Biometric authentication refers to a class of high tech recognition technologies that use human biometric traits to carry out person verification and identification. Biometric traits of a person, such as fingerprint, palm print, iris, deoxyribonucleic acid (DNA), are unique and stable for the individual; they cannot be duplicated, stolen and forgotten. Because each person's characteristics are distinct from others, it is possible to accurately identify a person by using his/her unique biometrics. Existing biometric recognition methods generally include face recognition, fingerprint recognition, sound recognition, palm print recognition, signature recognition, eye iris, retina recognition and so on.

As compared to other recognition technologies, face recognition technique is of many advantages such that it is natural, simple and convenient, easy to operate, user friendly, contactless, and non-intrusive, etc. It can complete the recognition task without incurring much disturbance. With this technology, people no longer need to worry about touching his fingerprint on the fingerprint device, or talking to the microphone, or looking into an iris scanner required by conventional recognition in the prior art. A face can be recognized when a person show his face to the camera. Therefore, the face recognition technology can be widely applied to access control, machine readable traveling documents (MRTD), e-passport, anti-terrorism, ATM, computer logon, safe cabinet, time attendance, and so on.

Typical face recognition applications include the following modes:

Identification (1:N match) to determine a person's ID: A system (1) acquires the face image data, (2) extracts facial features or record from the image, (3) compares it with all or part of the records of enrolled persons in database to calculate the similarity scores, and (4) produce a sorted list based on the similarity score. Finally, the system outputs the persons ID corresponding to the top most similarity if the top most similarity is above an acceptance threshold; otherwise concludes that the person is not identified.

Verification (1:1 match) to verify whether the claimant. In this case, the system needs just to compare the facial record extracted from the image with that of the claimed person to give the similarity score. The system either accepts the claimant if the similarity score is above an acceptance threshold, or reject if otherwise.

Surveillance: Using the techniques of face image acquisition and face recognition to track a person in the surveillance area and determines his location.

Monitoring: To discover the faces in the surveillance area, far or near, regardless of their locations, track them and separate them from the background, compare the facial features with those in the database. The entire process is automatic, continuous, and real-time.

The above application modes can be widely applied in the following domains:

Personnel identification and indexing: These can be used in computer/network security, bank services, smart card, access control, frontier control, etc.

ID card: This can be used in voter registration, ID card, passport, driver's license, work identification and so on.

Computer information safeguarding system: This uses the facial features to recognition user, safeguards the computer information.

Crime suspect recognition system: This system stores face pictures and recognizes faces in analyzing incidents.

Long-distance person identification: This is applied in surveillance, monitoring, TV, traffic control, enemy-friend recognition and so on.

A face recognition process is illustrated in FIG. 1. It consists of following three modules:

Image acquisition module 10: It captures face image or video images through image acquisition equipment (for example video camera, digital camera and so on), then, then sends these images or video to a computer.

Feature extraction module20: Residing in a computer processor, this module examines the input image, detects the face, locate facial features such as eyes and mouth, normalize the face in pose and illumination, and extracts face features (face code).

Feature matching module30: Also residing in the computer, it compares the face features extracted from the input image information (face code) with those stored in the database40, and find the best matched one.

Obviously, the face feature database should be set up before the face recognition process. Therefore, as shown in FIG. 2, a face recognition system should have two main parts: Face Recognition (Part A), and Face Enrollment (Part B). Among them, the purpose of Part B is to register related personal information for the person to be enrolled, extract the face code of the person, and store the information and face code in the database for face recognition process in the future.

Both enrollment and recognition (Parts A and B) include the image acquisition and feature extraction modules. Of these, the face recognition part has an additional feature matching (comparing) module, while the face enrollment part has a data saving module.

Face feature extraction process 20 is composed of several steps: face detection or tracking 201, facial feature localization and face normalization 202, face feature extraction (face code generation) 203. The face detection finds the face in the input image or video image sequence, so that the face is separated from the background; the face tracking tracks detected the faces in video image sequence, face normalization or alignment uses localized facial landmarks (eyes and/or mouth) to normalize the geometry of the face to a standard pose and normalize the lighting to a standard illumination condition, face feature extraction calculates the face code from normalized face image.

Face matching 30 compares the face code from the input with those of the enrolled persons in the database 40, one by one in turn, computes the similarity matching scores, and gives a decision for verification or identification after referring to a similarity threshold.

To achieve reliable and accurate accuracy, face recognition should be performed based on intrinsic factors of the face only, mainly of 3D shape and reflectance of the facial surface. Variations brought about by extrinsic factors, including hairstyle, eyeglasses, expression, posture, and environmental lighting, should be reduced or eliminated in order to achieve high performance.

Most of existing face recognition technologies are based on visible light images. Such technologies have difficulties in adapting to changes in environmental lighting: Changes in lighting cause changes in facial features; therefore, their accuracy deteriorates when the lighting of the face recognition environment differs from that of the face enrollment environment, for example, US Patent US2001/003102A1.

The research shows that the difference of facial image for same person by light change is much bigger than that of different persons. (Sees also Yael Adnin, Yael Moses and Shimon Ullman, “Face recognition: The problem of compensating for changes in illumination direction”, IEEE Transactions on Pattern Analysis and Machine Intelligence, Vol. 19, No. 7, 1,997, pp. 712-732). Existing face recognition technology depends on “passive” light source, that is, environmental light sources. Unfortunately, in real application, the environmental lights vary, and are not controlled. A change in environment light changes the captured facial image dramatically. This in turn significantly changes extracted face features, and causes significant drop in recognition accuracy.

Suppose for each point Pi, there is a vector nᵢ=(nₓ,n_{y},n_{z})^{T}, n^{T}i is a unit vector, that is ∥n∥=1; Assume that the light source is point source, the direction is s=(sₓ,s_{y},s_{z}), then we have the Lambertian imaging equation model, the gray scale Iᵢ of Pᵢ can be written as:

Iᵢ=ρᵢ(x, y)nᵢ(x, y)^{T}·s (1)

where i=1, 2, . . . , k, k is the number of pixels of a face image
pᵢ is the surface reflection rate of Pi
n^{T}i indicates the surface vector of the point i
· is the dot product operation
x,y,z is the 3-D coordinate of Pi

It can be seen from the above equation that the facial image formation is related to the reflection and 3-D shape of the face surface, and the illumination. These are the three essential factors in the facial image formation process. The first two terms are related with the intrinsic characteristic of the face itself, and also the important information for face recognition; the last term, illumination, is the extrinsic factor, and also the primary factor which affects face recognition performance.

Although the light intensity ∥s∥ also affects the gray scale of facial images, this kind of influence can be adjusted using a simple linear transform. The top-most factor that affects the face recognition performance is the incidence angle of the light relative to the face surface vector. Assume that θᵢ is the angle between the incident light ray and the face surface vector at Pi (θᵢ ε [0, π]), the light intensity ∥s∥=1, then Equation (1) maybe expressed as follows:

Iᵢ=ρᵢ(x, y)cos θᵢ (2)

where, i=1,2, . . . ,k; k is the number of pixels of a face image.

From equation (2), we can see that when is changes as a result of a change in the illumination direction, the facial image changes accordingly. It can also be illustrated by a correlation analysis: Given two facial images lighted from the left side and from the right side, respectively, the correlation coefficient of resulting images is generally a negative number; this means that the two images are completely different by the pixel values, even though of the same person.

In real applications, the environment lightings generally differ from place to place, and a face recognition system has to adapt to different environmental lightings. However, current face recognition technology mixes both intrinsic and extrinsic factors in the imaging and hence cannot adapt well to the environment This is why the best face recognition system can only achieve 50% accuracy (see also NIST 2002 Human Face Recognition Vendor Tests Evaluation Report (P. J. Phillips, P. Grother, R. J Micheals, D. M. Blackburn, E Tabassi, and J. M. Bone. March 2003).

Although there are many methods for compensation and normalization of illumination for face recognition, they are not very effective (see: P. N. Belhumeur, David J. Kriegman, “What is the set of Images of an Object Under All possible Lighting Conditions?”, IEEE conf. On Computer Vision and Pattern Recognition”, 1,996; Athinodoros S. Georghiades and Peter N. Belhumeur, “Illumination cone models for recognition under variable lighting: Faces”, CVPR, 1,998; Athinodoros S. Georghiades and Peter N. Belhumeur, ” From Few to many: Illumination cone models for face recognition under variable lighting and pose”, IEEE Transactions on Pattern Analysis and Machine Intelligence, Vol. 23, No. 6, pp 643-660, 2,001; Amnon Shashua, And Tammy Riklin-Raviv, “The quotient image: Class-based re-rendering and recognition with varying illuminations”, Transactions on Pattern Analysis and Machine Intelligence, Vol. 23, No. 2, Pp 129-139, 2,001; T. Riklin-Raviv and A. Shashua. “The Quotient image: Class based recognition and synthesis under varying illumination” In Proceedings of the 1,999 Conference on Computer Vision and Pattern Recognition, Pages 566-571, Fort Collins, Colo., 1,999; Ravi Ramamoorthi, Pat Hanrahan, “On the relationship between radiance and irradiance: Determining the illumination from images of a convex Lambertian object”, J. Opt. Soc. Am., Vol. 18, No. 10, 2,001; Ravi Ramamoorthi, “Analytic PCA Construction for Theoretical Analysis of Lighting Variability in Images of a Lambertian Object”, IEEE Transactions on Pattern Analysis and Machine Intelligence, Vol. 24, No. 10, 2002-10-21; Ravi Ramamoorthi and Pat Hanrahan, “An Efficient Representation for Irradiance Environment Maps”, SIGGRAPH 01, Pages 497-500, 2,001; Ronen Basri, David Jacobs, “Lambertian Reflectance and Linear Subspaces”, NEC Research Institute Technical Report 2000-172R; Ronen Basri and David Jacobs, Lambertian Reflectance and Linear Subspaces, IEEE Transactions on Pattern Analysis and Machine Intelligence, Forthcoming; Terence Sim, Takeo Kanade, “Illuminating the Face”, CMU-RI-TR-01-31, Sep. 28, 2001, etc) Among these methods, some requires 3-D modeling of faces, while some assumes known facial shapes. These limitations reduce the applicability. Moreover, the computational cost is very high.

There have been several face recognition patents, most of them using visible lights and for applications. One is Chinese patent ZL99117360.X. There, it is about how to implement the face recognition for access control and time attendance, without much attention paid to face image acquisition, and influence of skin complexion and light changes. The recognition accurate rate of this method under the lighting changes is still low. These limit its applications.

US Patent (US2001/0031072A1) disclosed a device using VISIBLE light sources to actively illuminate the face for face recognition. The device uses visible light as active light sources and hence inherits problems existing in current visible light image based face recognition; further, the visible light are intrusive to human eyes especially; this is especially true when the active lights should be strong enough to override environmental lightings, as is the case in US2001/0031072A1. That patent did not publicize how to use INVISIBLE infrared lights as active light sources to illuminate the face for facial image acquisition and recognition, nor is there any information there about how to setup infrared light sources and infrared filters for better face image acquisition and recognition.

There have also been iris recognition techniques for accurate biometric identification, such as used in Iridian Corporation's products. Disadvantages of such technology include complexity of iris image acquisition devices, and inconvenience of use. These limit the applications. Chinese patent ZL99110825.6 has also disclosed portable iris equipment. This equipment is limited by the similar disadvantages.

### SUMMARY OF THE INVENTION

The object of the present invention is to provide a method and an apparatus for facial image acquisition and/or facial image recognition that can overcome one or more problems existing in the prior art, such as the accuracy of face recognition is deteriorated due to changes of environmental lightings. The present invention aims to solve the problems of prior art by using a non-intrusive and user-friendly means, and to achieve accurate and fast face recognition.

A further object of the present invention is to provide a method and an apparatus for face image acquisition, wherein an active near infrared (NIR) light is used to illuminate the face during the acquisition of face images. The method and apparatus can significantly reduce unfavorable influence caused by variable environmental lights.

A further object of the invention is to provide a method and an apparatus for face recognition in which eyes and face in NIR facial images acquired with illuminating of active NIR light are localized by detecting specular highlight reflections in eyes under illuminating of active lightings. The present method can lead to accurate and fast face recognition.

The present invention provides a face recognition method, comprising the following steps:

providing an active infrared light to illuminate a target face when a user approaches an image capturing unit, wherein said active infrared light mounted around lens of an image capturing unit is near infrared (NIR) radiation light sources in invisible light spectrum,

capturing a plurality of facial images from a target face illuminated by said active NIR light sources, and sending a NIR facial image to a data processing unit;

localizing said face and/or eyes of said face, and cropping a portion of said facial image from said NIR facial image by said data processing unit;

extracting facial feature from said portion of said facial image;

comparing facial feature with that of previously extracted and stored in a facial image database;

outputting a recognition result obtained from said comparing step.

Said face recognition method is provided, wherein a NIR filter is disposed on said image capturing unit for cutting off visible light radiation while allowing the NIR light radiation to pass through, so as to improve NIR face image acquisition.

Said face recognition method is provided, further comprising the steps of:

detecting specular highlight reflections in eyes in said NIR face image to localize eye positions and thereby localize said face.

Said face recognition method is provided, further comprising the steps of:

judging whether eyes and/or face is successfully localized after sending at least one facial image to a data processing unit; if yes, going forward to the next step of cropping a portion of said facial image, otherwise repeating the localizing step until eyes and/or face is successfully localized.

The present invention further provides a facial image acquisition method, comprising the steps of:

providing a plurality of active infrared lights to illuminate a target face, wherein said active infrared light mounted around lens of an image capturing unit is a near infrared (NIR) light in invisible spectrum;

providing an image capturing unit for capturing NIR images of said target face, and sending/storing said NIR face images to a data processing unit used for localizing and recognizing said target face;

wherein the total energy of said active NIR light plus said environmental lightings on entire area of said target face is greater than that of environmental lightings on entire area of said target face by at least twice times.

Said facial image acquisition method is provided, wherein a NIR filter is disposed on said image capturing unit for cutting off a visible light radiation while allowing a NIR light radiation to pass through, so as to improve NIR facial image acquisition.

The present invention further provides a facial image acquisition apparatus used for realizing a facial image acquisition method, comprising an active NIR light and an image capturing unit;

Said active NIR light is mounted around lens of said image capturing unit to illuminate a target face;

Said image capturing unit captures NIR images of said target face illuminated by said active NIR light, and sends said NIR images to a subsequent data processing unit.

Said facial image acquisition apparatus is provided, wherein a NIR filter is disposed on said image capturing unit for cutting off visible light radiation while allowing the NIR light radiation to pass through, so as to improve NIR face image acquisition.

Said facial image acquisition apparatus is provided, wherein the spectrum range of said active NIR light is between 740 nm-1700 nm; said NIR optical filter is an NIR optical coating or an NIR optical glass disposed on the surface or inside of said lens.

Said facial image acquisition apparatus is provided, wherein said active NIR light comprises a plurality of constant NIR lights, or a plurality of flash NIR lights, or the combination thereof.

Said facial image acquisition apparatus is provided, wherein the direction of said active NIR light is approximately parallel to axis of said lens.

Said facial image acquisition apparatus is provided, wherein the total energy of said active NIR light plus said environmental lightings on entire area of said target face is greater than that of environmental lightings on entire area of said target face by at least twice times.

Said facial image acquisition apparatus is provided, wherein said image capturing unit includes an NIR optical filter of band-wavelength-pass or long-wavelength-pass type.

The present invention further provides an facial image recognition apparatus used for realizing the above facial image recognition method, comprising an active infrared lighting, an image capturing unit and a data processing unit;

wherein said image capturing unit includes a lens; and said active infrared light comprises a plurality of active NIR lights used for illuminating a target face and mounted around said lens;

said image capturing unit is used for capturing facial images and sending at least one facial image to said data processing unit;

said data processing unit comprises a PC or an embedded processor in which image processing software is installed, used for receiving images from said image capturing unit and localizing eyes and face in said facial images, and extracting facial features in said localized facial area, and comparing the extracted features with that of previously stored in a facial image database.

Said facial image recognition apparatus is provided, wherein the spectrum range of said active NIR light is between 740 nm-1700 nm; said active NIR light comprises a plurality of constant NIR lights, or a plurality of flash NIR lights, or the combination thereof.

Said facial image recognition apparatus is provided, wherein the direction of said active NIR light is approximately parallel to axis of said lens.

Said facial image recognition apparatus is provided, wherein said image capturing unit includes an NIR optical filter of band-wavelength-pass or long-wavelength-pass type, and it is used to suppress visible lights while allowing NIR lights to pass through so as to achieve better NIR imaging effect.

Said facial image recognition apparatus is provided, wherein said data processing unit includes a means for detecting specular highlight reflection in each eyes in said NIR face image, it is used for localizing said eyes and face through localizing the positions of a highlight spots.

Said facial image recognition apparatus is provided, wherein there is a displaying device for displaying facial images, used for adjusting the position of the target face in vertical and horizontal directions; said displaying device is a mirror or an LCD (liquid crystal displace), mounted in such a way that its surface normal is co-axis to said lens.

Said facial image recognition apparatus is provided, wherein said active NIR light can be controlled by a power switch, a proximity sensor switch or an RFID controlled switch.

The present invention can effectively overcome a main problem existing in current visible light image based face recognition methods and systems that their accuracy drops because of the unfavorable impact of uncontrolled environmental lighting on facial images, and therefore can increase the recognition accuracy under uncontrolled environmental lighting.

The above advantages are realized by the invented NIR face image acquisition method and device wherein active NIR lights, strong enough to override environmental lighting, are used to illuminate the face during image capturing and at the same time visible lights in the uncontrolled environment are suppressed using an NIR optical filter. Therefore, the invention leads to stable imaging properties and hence high recognition accuracy under different lighting environments.

Moreover, the invented face image acquisition method and apparatus are user-friendly because the active NIR lights are in the invisible spectrum and cause no disturbance to human eyes.

The advantages are further realized by the method and apparatus for the NIR facial image acquisition and recognition, wherein highlight specularities in the eyes are located quickly and accurately. The facial feature template extracted based on accurate eye localization can represent the face accurately and hence lead to high recognition accuracy.

### BRIEF DESCRIPTION OF THE DRAWINGS

FIG. 1 is a schematic diagram of a face recognition process;

FIG. 2 is a schematic flowchart diagram including both face recognition and enrollment processes;

FIG. 3 is a schematic illustration of a angle between an active light direction and camera lens axis;

FIG. 4 is a schematic illustration of an exemplar system that embodies a face recognition method in the present invention;

FIG. 4a is a procedure for an embodiment of a face recognition method in FIG. 4;

FIG. 4b is a diagram of an image acquisition and data processing modules for a system in FIG. 4;

FIG. 5 illustrates specular highlight reflections in eyes as reflection of active lighting on the eye surface;

FIG. 6 is a schematic diagram of an image capturing unit with active lights;

FIG. 7 is a schematic illustration of an access control system with the present invention of face recognition method incorporated;

FIG. 8 is a schematic illustration of an application of the present invention of face recognition method in machine readable travel document (MRTD);

FIG. 8a is a schematic diagram of a face image acquisition in the face recognition based MRTD system in FIG. 8;

FIG. 8b is a schematic diagram of a face recognition in a face recognition based MRTD system in FIG. 8.

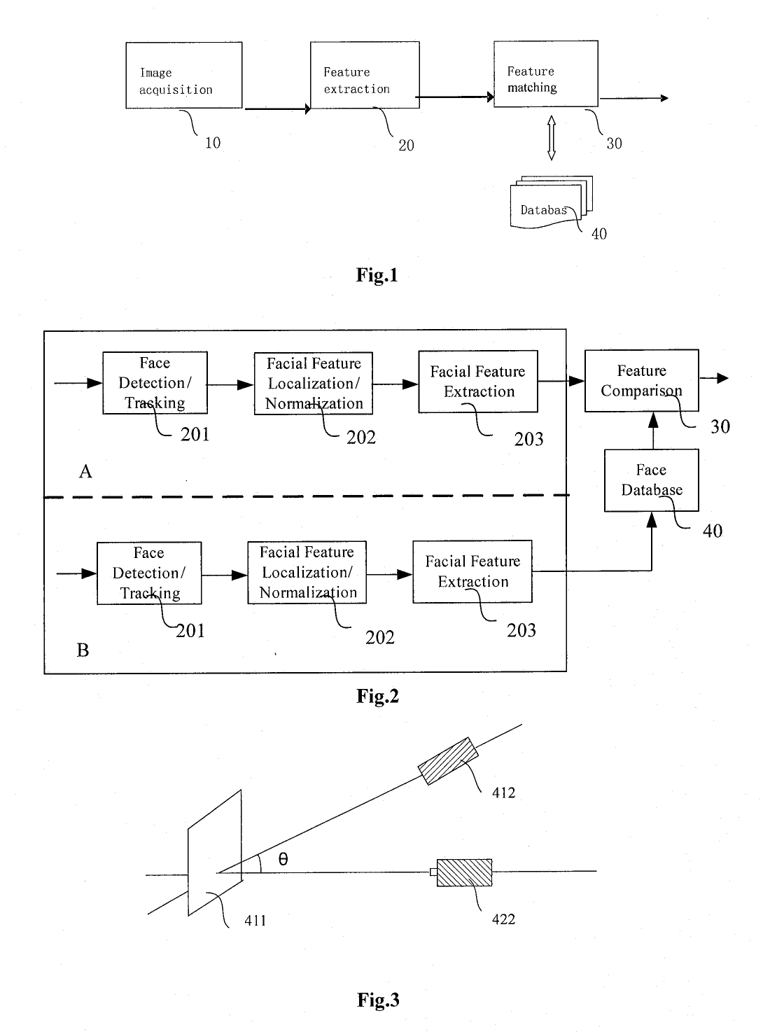

### DETAILED DESCRIPTION OF THE PREFERRED EMBODIMENTS

Detailed embodiments of the present invention are disclosed herein, with an illustrative drawings and an exemplar embodiment:

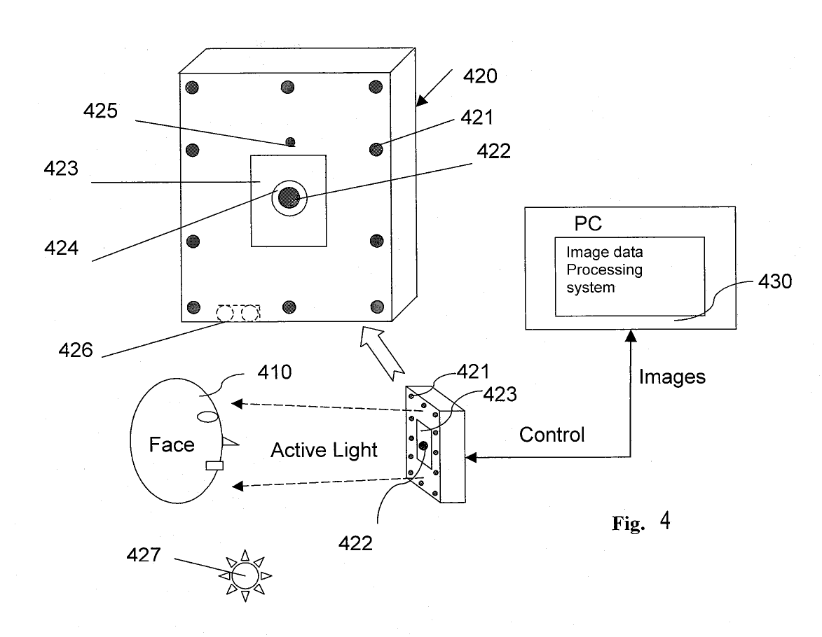

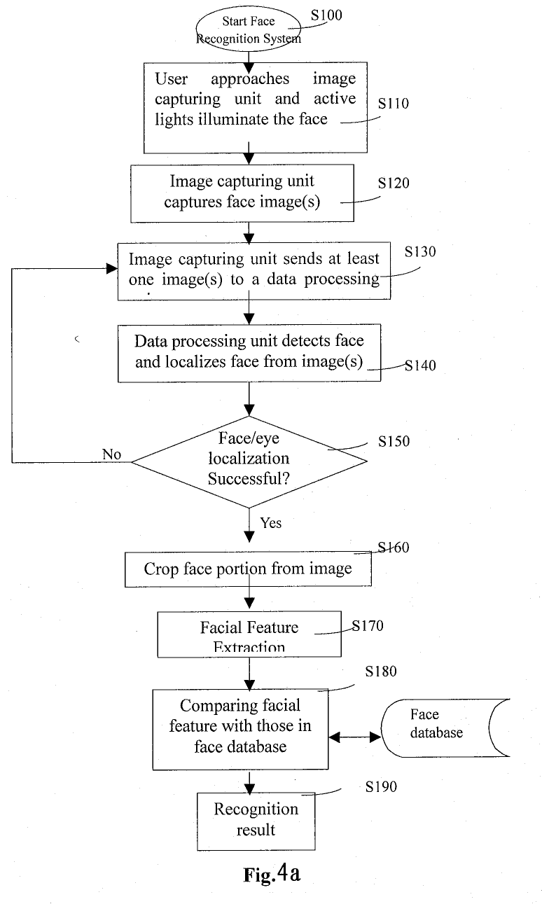

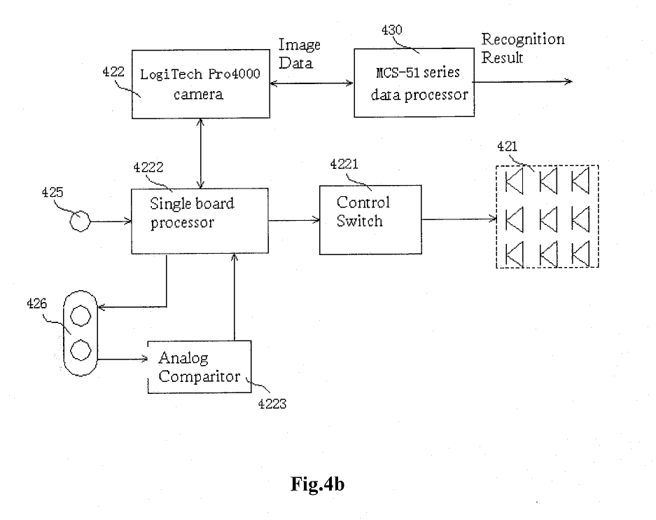

FIG. 4 discloses a preferred embodiment of an imaging system including image acquisition apparatus and/or image recognition apparatus according to the present invention, comprising active lights (LED) 421, camera 422, mirror (as an aid for face positioning) 423, optical filter 424, control switch 426, data processing unit 430, indicator LED, and power supply; an active light (LED) are evenly distributed around the camera422, and in the middle are the mirror 423, the filter 424 and the camera 422; the mirror 423 is in the middle of the box of the imaging system, in the middle of the mirror is the filter 424 and the camera 422; the mirror 424 is inside or in frontal of the camera lens. The camera is connected electronically to the data processing unit. The control switch 426 is a infrared sensor switch, located in the lower part of the imaging box. an indicator illuminator is located above the camera 422. The control switch 426 is connected to the active lights 421, the camera 422, illuminator 425, and the power supply, when an infrared sensor in the switch 426 is triggered on, the switch 426 turns on the active lights 421 and the camera 422, and the illuminator 425 turns red and blinking, meaning active lights and the camera are working; when the switch 426 turns off, the active lights 421 and the camera 422 stop, and the illuminator turns green, meaning standby.

First, the active lights 421illuminate on the face area 410, the camera 422 (which can be a web camera, a CCTV camera, or specialized infrared camera) captures an image of the face 410; the acquired image is transmitted to the data processing unit where face image recognition takes place.

FIG. 4a reveals an embodiment of a face recognition apparatus given in the present invention, including the following steps:

Step 100, start a face image acquisition system 420;

Step 110, when human body approaches the system 420, an infrared sensor is triggered on, and the active lights 421 illuminate the face area;

Step 120, the camera 422 captures images of the face area illuminated by the active lights 421;

Step 130, the camera 422 sends at least one face image to the data processing unit (such as a PC or an embedded data processor) 430;

Step 140, the data processing unit 430 finds the face from the image and locates the positions of the eyes and/or face;

Step 150, if the eye/face localization is successful, execute step 160; Otherwise, execute step 130;

Step 160, crop the face area from the image;

Step 170, extract facial feature template;

Step 180, compare the extracted facial feature template with those stored in the face template database;

Step 190, output recognition result.

In the above steps, the total energy of the active lighting 421 and the environmental lighting 427 on the face area is greater than twice that of environmental lighting. For example, if the strength of the environment lighting is 30 LUX, and that of the active lighting is 120 LUX then the strength of the active lighting is 4 times that of the environmental lighting.

In FIG. 4 and FIG. 4a, the active lights 421 are NIR lights. Generally, active NIR lights in the present invention can include constant NIR lights, flash NIR lights, and/or a combination of them. The strength of the active NIR lights are much greater than that of environmental lights, hence the influence of the latter is much reduced. Similar effect could be achieved using visible lights.

However, because NIR lights are in the invisible spectrum, human eyes are insensitive to them, and the active infrared lights cause minimum disturbance to the human; meanwhile, an NIR optimal filter 412 can be added into the cameras, to cut off visible lights in the environmental lighting, so as to further reduce the influence of environmental lighting; therefore, NIR lights are the most suitable type of active lights.

In any embodiment of the present invention, whatever type of active lights are used to illuminate the face, the relative position between the active lights and the camera should be relatively fixed, and the angle between the direction of the active lighting and the axis of the camera lens should be in a sharp angle.

Refer to FIG. 4. During the enrollment and recognition processes, the relative position between the face 410 and the camera 422 should not be changed, and the face plane and the axis of the camera 422 should be perpendicular to each other (i.e. the vector normal to the facial plane should be parallel to the axis of the camera); as such, the angle θ between the normal vector and the camera axis is relatively unchanged, and the resulting image is most stable under the active lighting.

When infrared lighting is used, an infrared optical filter can be mounted on the camera lens, so as to cut off the shorter wavelength visible lights, and to further reduce the influence of environmental lights. For the present invention, the preferred infrared lights are of near infrared in the wavelength range of 740 nm-1700 nm.

When an infrared optical filter is used, the filter can be either band-pass or long-pass type. For example, when the infrared lights are 850 nm LEDs, a band-pass filter could be chosen, such that it has the central wavelength of 850 nm to allow infrared ray of around 850 nm to pass while cutting of ray of wavelengths shorter than 800 nm and longer than 900 nm; or a long-pass filter could be chosen, such that it allows infrared ray of wavelength longer than 800 nm to pass, while cutting off ray of wavelengths shorter than 800 nm.

In FIG. 4 and FIG. 4b, a data processing unit 430 in the present invention can be one of PC or an embedded data processor (of FIG. 4b).

In FIG. 4b, to simplify the device, one could integrate all components into one circuit board and install the board in a casing box; the board circuits include the infrared sensor switch 426, analog comparator 4223, single-chip microcomputer 4222, camera 422 (eg LogiTech Pro4000), control pecker 4221, active lights 421 (near infrared LED array), and imbedded data processor 430 (eg MCS-51 series).

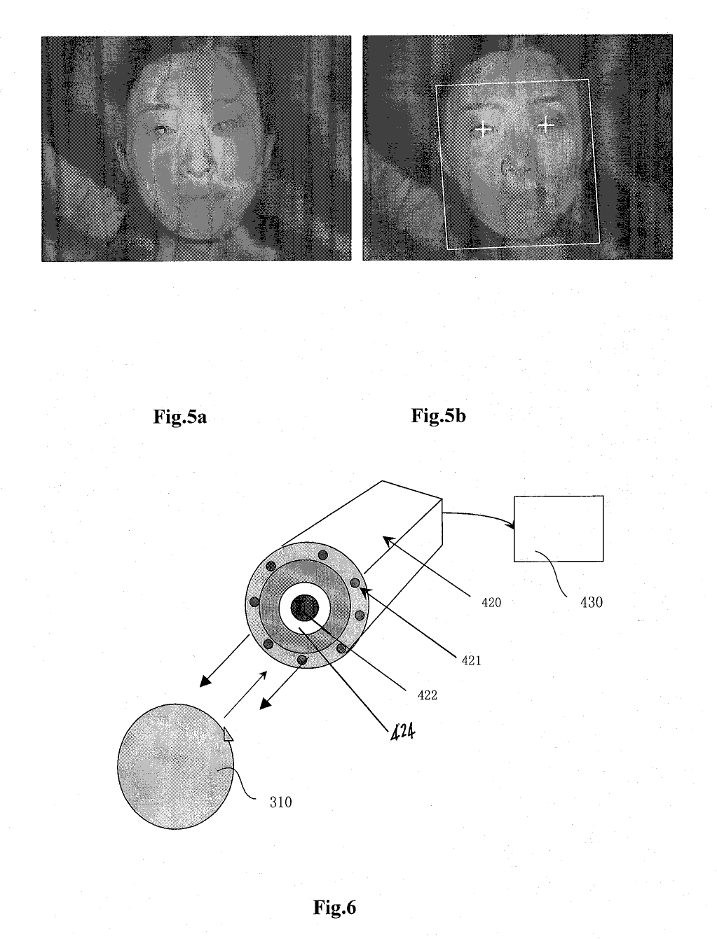

In FIG. 5a and FIG. 5b, one could make use of the specular highlight reflections in the eyes (FIG. 5a) for the eye and face localization, which is an effective and computationally efficient means. The active infrared lights cause a specular highlight reflection in an eye, which can be seen in the face image. Therefore, one can detect the eyes and the face by detecting the highlights in the eyes. After the two highlights in the eyes are detected, one can locate the face area according to the geometric relationship between the two eyes and that between the eyes and the face. This enables fast and accurate face localization and much simplifies the face detection problem.

Refer to FIG. 3 again. Let the angle between the active light direction and the camera axis be θ, environmental light be S₁ and active light be S₂, then the aformentioned equation (1) can be written as

Iᵢ=ρᵢ(x, y)nᵢ(x, y)^{T}·(s₁+s₂) (3)

where i=1,2, . . . ,k;

If the strength of the active lighting S₁ is much greater than that of the environmental lighting S₂, i.e. ∥S₁∥>>∥S₂∥, then equation (3) can be approximated by:

Iᵢ≈ρᵢ(x, y)nᵢ(x, y)^{T}·S₁ (4)

where i=1,2, . . . ,k;

If in the process of face recognition, a further constraint is imposed, namely, the relative position between the face and the camera is un-changed and so is the angle between the facial surface normal and active light direction, then according to equation (4), the acquired image is determined by the intrinsic properties of the face (ie, facial surface albedo and facial surface normal), nearly regardless of environmental lighting. Facial images acquired in such as way is most stable and best for face recognition.

### Applications

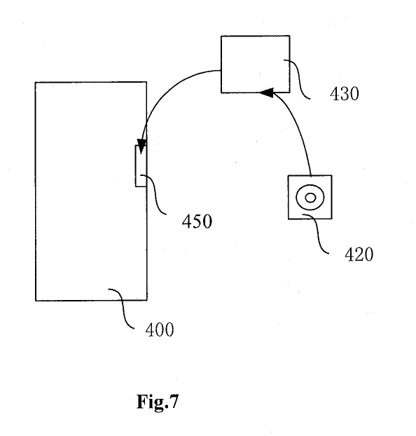

FIG. 6 and FIG. 7 disclose an embodiment of the present invention for face recognition based access control.

Refer to FIG. 7. On a door 400 is an access controller 450. The active light image acquisition system 420 transmits the face image to the data processing unit 430, the data processing unit 430 makes a decision, and send the decision to the controller 450 to grant or deny the access.

In FIG. 6 and FIG. 7, the imaging system 420 includes 8-12 infrared LEDs of wavelength 850 nm. The LEDs are mounted in frontal of the camera, in co-axis to the camera lens (the angle is 0 degree when the facial plane is perpendicular to the active light direction). With the 850 nm band-pass infrared filter 423, the ray of 850 nm LEDs can pass through the filter, whereas ray of other wavelength is cut off. Or a long-pass filter may be used to allow ray of wavelength above 800 nm to pass while cutting off ray below 800 nm. The camera captures images of the face 410, and sends them to the data processing unit detects the positions of the eyes and hence that of the face; the pose of the face is then corrected, and facial feature template extracted and compared; a recognition decision is made. The data processing unit then sends a signal to the controller according to the decision result to control the access of the door. In this embodiment the data processing unit is a desktop PC.

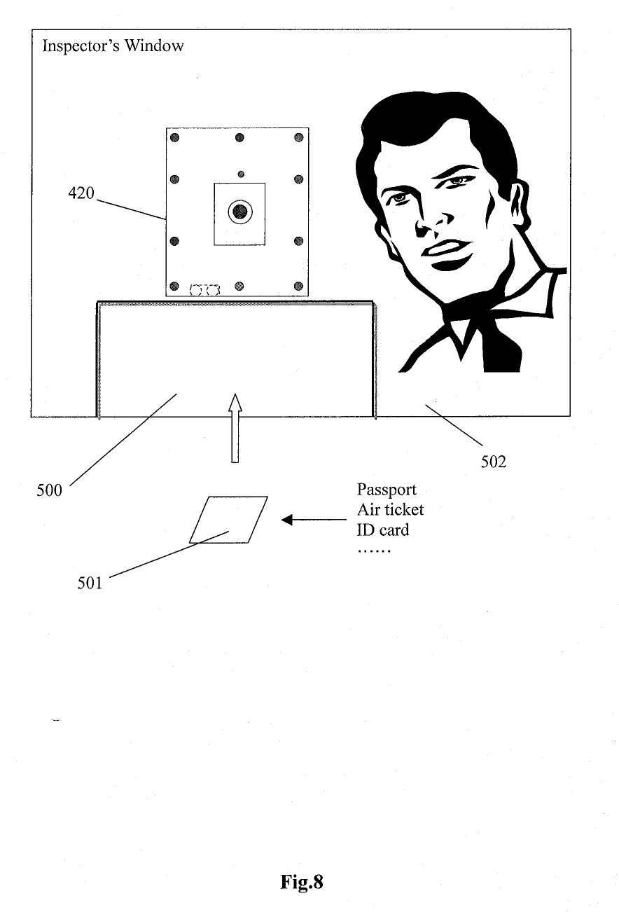

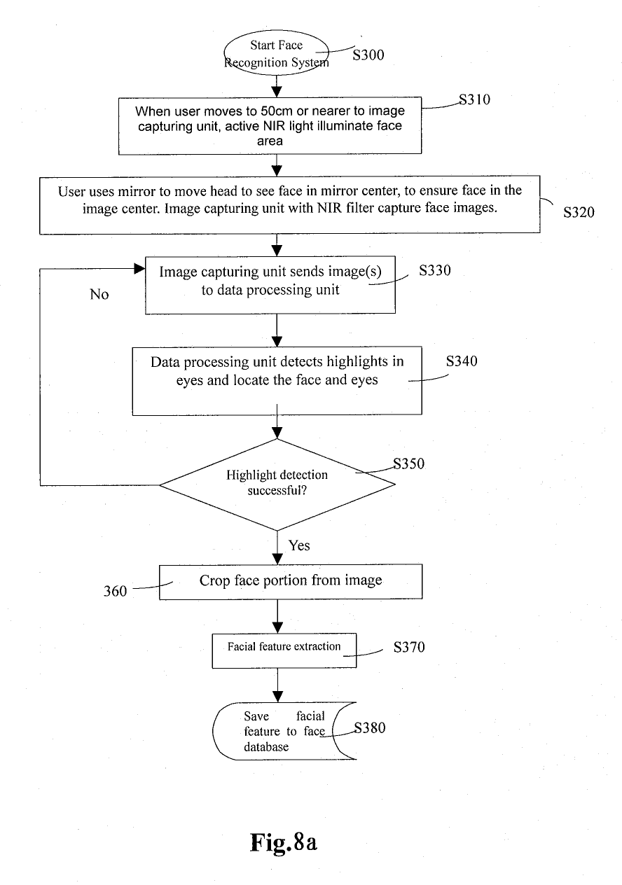

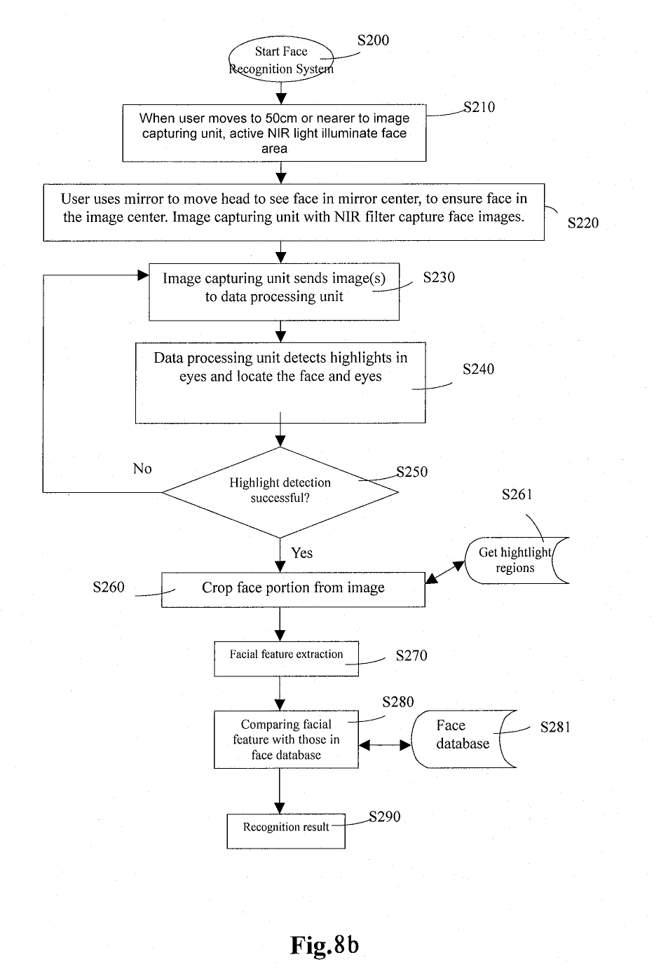

FIGS. 8, 8a and 8b disclose another embodiment of the present invention for face biometric based machine readable travel document (MRTD). The first phase is face image enrollment, shown in FIG. 8a, including the following major steps:

Step 300, start an image enrollment system;

Step 310, the passenger hands in the travel document 502 when the body approaches to within about 50 cm from the counter 500. The infrared sensor switch turns on the active lights (near infrared LEDs) to illuminate the face area;

Step 320, the passenger moves his head so that he can see his face in the middle of the mirror, so that the active light camera with an optical filter can take pictures of the face;

Step 330, the camera captures at least one image and send it to the data processing unit (or a PC);

Step 340, the data processing unit locates the two highlight spots from the image;

Step 350, if two highlights are detected, execute S360, otherwise, execute S330;

Step 360, crop the face area from the image, based on the two detected highlight spots;

Step 370, extract facial feature template(s);

Step 380, store the extracted facial template(s).

FIG. 8b discloses further details of face image acquisition and processing, including the following steps:

Step 200, start a face recognition apparatus;

Step S210, the passenger hands in the travel document 502 when the body approaches to within about 50 cm from the counter 500. The infrared sensor switch turns on the active lights (near infrared LEDs) to illuminate the face area;

Step 220, the passenger moves his head so that he can see his face in the middle of the mirror, so that the active light camera with an optical filter can take pictures of the face;

Step 230, the camera captures at least one image and send it to the data processing unit (or a PC);

Step 240, the data processing unit locates the two highlight spots from the image;

Step 250, if two highlights are detected, execute S360, otherwise, execute S230;

Step 260, crop the face area from the image, based on the two detected highlight spots;

Step 270, extract facial feature template; Step S280, compare the extracted facial template with those stored in the database;

Step 290, output recognition result.

In real applications, the face enrollment system and the face recognition system can be built into one combined system. The difference is that the latter does not include the enrollment phase. The custom inspector checks the documents against the enrolled passenger, associate the personal information with the enrolled facial image, and test whether the person can be verified his identity successfully by the system.

In the embodiment shown in FIG. 8, the mirror can be replaced by an LCD display, so that the user can adjust the head position according to the feedback image shown on LCD. One may use a digital camera type device as an image capturing unit and also use it as the display.

Further, the imaging system of the present invention can be on a motion platform, to be an elevator-pan-tilt-zoom camera unit. Such a device can track the people, control the active lights, and capture face images. It also caters for people of different heights.

The present invention can enable face recognition in the complete darkness without environmental lighting.

The present has further advantages such as being highly accurate and stable, compact low in cost, autonomous, convenient to use in various applications and for installation and maintenance.

New characteristics and advantages of the invention covered by this document have been set forth in the foregoing description. It will be understood, however, that this disclosure is, in many respects, only illustrative. Changes may be made in details, particularly in matters of shape, size, and arrangement of parts, without exceeding the scope of the invention. The scope of the invention is, of course, defined in the language in which the appended claims are expressed.

What is claimed is:

1. A method for person identification by biometric analysis of facial images, comprising the steps of:
starting a face recognition apparatus;
providing an active lights to illuminate a target face when an user approaches said face recognition apparatus;
providing an image acquisition unit to capture a plurality of images from a target face illuminated by an active lights;
sending at least one facial image acquired by said image capturing unit to a data processing unit, and detecting and/or localizing a positions of eyes and/or said face by said data processing unit;
cropping a portion of said facial image and extracting facial feature from said portion of said facial image by said data processing unit;
comparing facial feature with that of previously extracted and stored in a face database;
outputting a recognition result obtained from said comparing step.

2. The method of claim 1, wherein said active lights are near infrared lighting sources, or visible light sources, or flash lights, or any combination of them.

3. The method of claim 1 or 2, wherein a total energy of an active lighting and environmental lighting on said face area is greater than that of environmental lighting.

4. The method of claim 3, wherein a total energy of active lights and environmental lightings on said facial area is greater or equal to twice an energy of said environmental lightings.

5. The method of claim 2, wherein, after sending at least one facial image to a data processing unit, said method further includes a step of judging whether localizing eyes and/or face is successful; if yes, execute next step, otherwise do localizing step again;

6. The method of claim 1, 2, 4 or 5, wherein a step of sending at least one face image, there includes a step of detecting specular highlights in the eyes in said face image and thereby detecting eye positions.

7. The method of claim 6, wherein said method further includes a step that said image capturing unit can track said face area illuminated by an active lights.

8. A method for facial image acquisition, comprising the steps of:
Providing a plurality of active lighting to illuminate a face area,
Providing an image capturing unit for capturing a facial image of a target face, and sending said facial image to a data processing unit used for localizing and recognizing said target face;
Wherein a total energy of said active lighting and said environmental lighting on said face area is greater than that of environmental lighting.

9. The method of claim 8, wherein a total energy of said active lighting and said environmental lighting on said face area is greater or equal to twice an energy of said environmental lighting.

10. The method of claim 8 or 9, wherein a relative position between said active lighting and said image apparatus is relatively fixed, and a direction of said active lights and an axis of a camera lens of said image apparatus are in a sharp angle.

11. A method according to in claim 8, wherein said active lighting are near infrared light sources, or visible light sources, or flash lights, or any combination of them.

12. The method of claim 11, wherein said data processing unit can make use of the specularity in each of the eyes to localize the eye position, after a facial image is captured.

13. A facial image acquisition apparatus used for realizing the method of claim1, comprising an active light, an image capturing unit, a power switch and a data processing unit;
Said active lights used for illuminating a face area;
Said power switch use for controlling said active lights to illuminate said face area;
Said image capturing unit used for capturing facial images of said face area, and sending at least one facial image to said data processing unit;
Said data processing unit used for receiving images from said image capturing unit, and localizing eyes and face in said facial image, cropping a portion of said facial image, and extracting facial features, and comparing facial features with that of previously extracted and stored in a facial image database.

14. The apparatus of claim 13, wherein a total energy of said active lights and said environmental lighting on said face area is greater than an energy of said environmental lighting.

15. The apparatus of claim 14, wherein a position of said active lighting and said image capturing unit is relatively fixed, and a angle between a direction of said active lighting and a axis of the camera lens of said image apparatus between 0° to 90°.

16. The apparatus of claim 15, wherein the direction of said active lights is approximately parallel to an axis of a camera lens.

17. The apparatus of claim 15 or 16, wherein said active lights are near infrared light sources, or visible light sources, or flash lights, or any combination of them.

18. The apparatus of claim 17, wherein wavelength of said active lights are in a range of 740 nm-4000 nm, or a plurality of several wavelengths in said range.

19. The apparatus of claim 14, 15, 16 or 18, wherein an infrared filter is disposed on an infrared camera lens for cutting off visible lights radiation while allowing near infrared light radiation to pass through.

20. The apparatus of claim 19, wherein said infrared optical filter is of ban-pass or long-pass type, to suppress active lights while allowing infrared active lights to pass.

21. The apparatus of claim 14, 15, 16, 18 or 20, wherein there is a display device for displaying facial image, used for adjusting the position of a target face in vertical and horizontal directions.

22. The apparatus of claim 21, wherein said displaying device is a mirror or an LCD (liquid crystal displace).

23. The apparatus of claim 13 or 22, wherein said image capturing unit is a video camera or a digital camera.

24. The apparatus of claim 13, wherein said data processing unit comprises a PC/computer or an embedded processor in which image processing software is installed.

25. The apparatus of claim 13, wherein said power switch is a proximity sensor switch or an RFID controlled switch.

26. The apparatus of claim 13, 14, 16, 17, 18, 19, 20, 22, 24 or 25, wherein said active lights are mounted around a lens of said image capturing unit.
